(19) United States
(12) Patent Application Publication
(10) Pub. No.: US 2011/0195743 A1
(43) Pub. Date: Aug. 11, 2011

(54) METHOD AND APPARATUS FOR POWER MANAGEMENT

(75) Inventors: Junghoon Jee, Daejeon (KR); Chang Min Park, Daejeon (KR); Hong Seok Jeon, Daejeon (KR); Yoon Young An, Daejeon (KR)

(73) Assignee: Electronics and Telecommunications Research Institute, Daejeon (KR)

(21) Appl. No.: 13/063,867

(22) PCT Filed: Sep. 11, 2009
(86) PCT No.: PCT/KR2009/005155

§ 371 Date: Mar. 14, 2011

(30) Foreign Application Priority Data
Sep. 12, 2008 (KR) 10-2008-0090501
May 4, 2009 (KR) 10-2009-0038951
Sep. 8, 2009 (KR) 10-2009-0084419

(51) Int. Cl. H04B 7/24

(52) U.S. Cl. 455/522

(57) ABSTRACT

In an apparatus and a method for power management, it is possible to minimize power consumption by starting an application service by selectively using a heterogeneous network interface of a terminal mounted with a plurality of heterogeneous networks.

### TECHNICAL FIELD

The present invention relates to an apparatus and a method for power management in a terminal mounted with heterogeneous network interfaces.

More particularly, the present invention relates to an apparatus and a method for minimizing power consumption by selectively using only a heterogeneous network interface depending on the position of a terminal.

### BACKGROUND ART

A terminal is mounted with a plurality of heterogeneous network interfaces in order to perform communication between heterogeneous networks. However, as the number of mounted heterogeneous interfaces increases, power consumption increases.

### Disclosure

### Technical Problem

The present invention prevents an increase in power consumption as the number of interfaces mounted on a terminal increases.

### Technical Solution

It is possible to minimize power consumption by starting an application service by selectively using a plurality of heterogeneous network interfaces mounted on a terminal by utilizing information on a list of heterogeneous networks that are accessible at the current location of the terminal managed by a power management apparatus.

An embodiment of the present invention provides a power management apparatus that includes: a storage unit that stores a map displaying a communication coverage area of a heterogeneous network; a receiver that receives location information of a terminal mounted with heterogeneous network interfaces and state information indicating states of the heterogeneous network interfaces; and a manager that manages a list of heterogeneous networks that are accessible at the current location of the terminal by using the map stored in the storage unit, the location information, and the state information.

Another embodiment of the present invention provides a method of managing a power in a power management apparatus. The method includes: storing a map displaying a communication coverage area of a heterogeneous network; receiving location information of a terminal mounted with heterogeneous network interfaces and state information indicating states of the heterogeneous network interfaces; and managing a list of heterogeneous networks that are accessible at the current location of the terminal by using the map, the location information, and the state information.

### DESCRIPTION OF DRAWINGS

FIG. 1 shows a heterogeneous network coverage distribution map.

FIG. 2 shows a positional management system according to an embodiment of the present invention.

FIG. 3 shows a process of updating information by referring to states of network interfaces in a power manager according to an embodiment of the present invention.

FIG. 4 shows a paging processing process for a multimode terminal according to an embodiment of the present invention.

FIG. 5 shows one example of when a predetermined heterogeneous network interface is in an “activated” state during a paging processing process for a multimode terminal.

### MODE FOR INVENTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

As an embodiment of the present invention, a terminal includes heterogeneous network interfaces that perform connection with a heterogeneous network. In an embodiment of the present invention, a multimode interface may be defined as a type in which various kinds of heterogeneous network interfaces are integrated, or as a term including some or all kinds of a plurality of network interfaces additionally attached to the terminal, etc. In addition, the multimode interface may be substituted and changed by various implementation schemes.

In an embodiment of the present invention, a multimode interface may include all other kinds of interfaces, such as a WiMAX network interface, a WiFi network interface, etc.

In an embodiment of the present invention, the state of the multimode interface may be divided depending on whether power is supplied or not, and a network connection state. For example, the state of the multimode interface may be divided into a Power_ON state and a Power_OFF state depending on whether power is supplied or not. Further, in the “Power_ON” state in which the power is supplied to the multimode interface, the connection state of each network interface may be generally divided into an activated state and a deactivated state.

The activated state means a state in which an application service can be immediately performed through a predetermined network interface. Examples of the activated state include a sleep state of the WiFi and WiMAX interfaces, a READY state of a GPRS and an ACTIVE state of the GPRS in which the application service is actively transmitted and received, and the like. Since the sleep state of the WiFi and WiMAX is a state in which association and registration has been performed with an access point (AP) and a base station (BS) and packets are not consecutively transmitted and received, but is a state in which an L2 connection is maintained such that the application service can be immediately started, it is regarded as an activated state.

The deactivated state means a state requiring state switching in order to perform the application service. In the deactivated state, schematic information on the position of the terminal is managed by the unit of a location area on a network. Examples of the deactivated state include an idle state of the WiMAX interface, a standby state of the GPRS, and the like.

In an embodiment of the present invention, the state of the multimode interface may be divided depending on the network connection state. For example, when reception traffic is generated in the terminal at a predetermined timing, the state of the multi-mode interface may be divided and set depending on whether or not the corresponding traffic can be processed through the network interface.

As a detailed embodiment, the state of the multimode interface may be set to a state (REACHABLE_DIRECTLY) in which an application service session can be started with respect to the reception traffic through the corresponding network interface, in a state (NON_REACHABLE) in which communication cannot be started through the corresponding network interface, a state (REACHABLE_INDIRECTLY) in which the communication cannot be started through the corresponding network interface but the application service session can be started by switching a state of the network interface that cannot start the communication through another network interface attached to the terminal into the activation state, etc.

However, the above-mentioned states of the multimode interface are an embodiment of the present invention, and it should be understood that the states of the multimode interface may be variously set through network administrator set-up, and substitution and change of a configuration, etc.

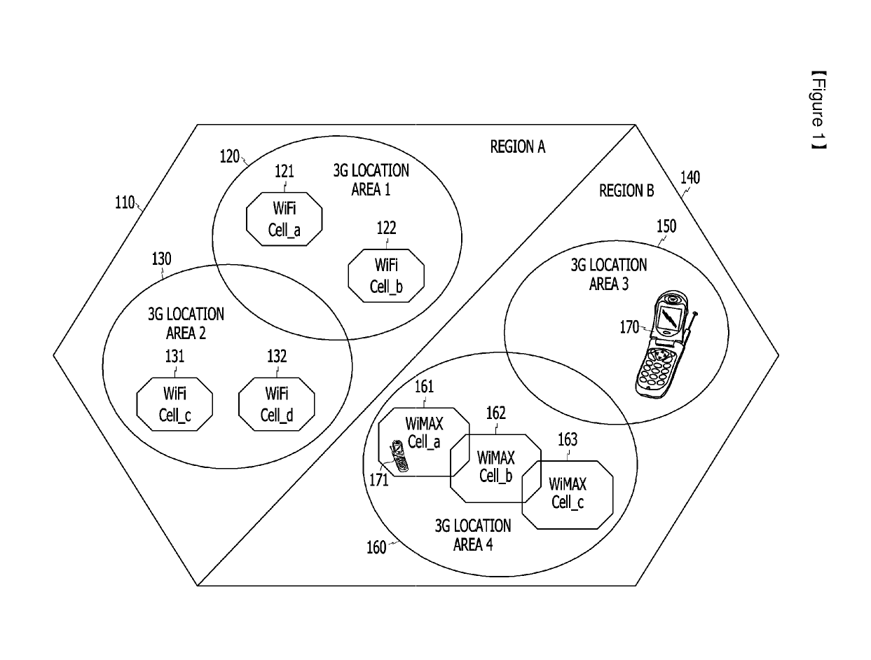

FIG. 1 shows a heterogeneous network coverage distribution map.

The heterogeneous network coverage distribution map provides the status of wireless heterogeneous networks distributed according to the position for each physical location, location information of a broadband wireless access network, narrowband wireless hotspot cell information, etc.

Referring to the heterogeneous network coverage distribution map shown in FIG. 1, in a region REGION A 110, 3G networks 120 and 130 are distributed in a broadband range and narrowband WiFi hotspot cells 121, 122, 131, and 132 are partially distributed in the 3G broadband networks 120 and 130. The 3G network as an abbreviation for a 3rd generation network, and corresponds to a network such as a UMTS.

In a region REGION B 140, broadband 3G networks 150 and 160 are distributed in a broadband range, and WiMAX hotspot cells 161, 162, and 163 are distributed only in a location area 4 160 unlike the region REGION A 110.

The state of the multimode interface will be described below with reference to the detailed embodiment. First, the state of the multimode interface depending on whether or not the power is supplied will be described.

In FIG. 1, when a terminal 170 is within the area 150, both the WiFi network interface and the WiMAX network interface of the multimode interface are set to a Power_OFF state.

When the terminal 170 moves and is within the area 161, the WiFi network interface of the multimode interface is set to the Power_OFF state and the WiMAX network interface is set to a Power_ON state.

The state of the multimode interface that is set depending on the network connection state will be described below.

When the terminal is within the 3G location area 1 120, a cellular network interface among the multimode interfaces is in a REACHABLE-DIRECTLY state and the WiMAX network interface is in a NON_REACHABLE state.

When the terminal is within the area 121 of the 3G location area 1 120, the WiFi network interface is in the REACHABLE_DIRECTLY state in the case of the Power_ON state or the WiFi network interface is in the REACHABLE_INDIRECTLY state in the case of the Power_OFF state.

That is, when the terminal is positioned in the WiFi network coverage 121 although the WiFi network interface is in the Power_OFF state, the terminal can start the application service session by switching into the activated state by performing Power_ON through another network interface in the REACAHBLE_DIRECTLY state (for example, the cellular network interface within the area 120).

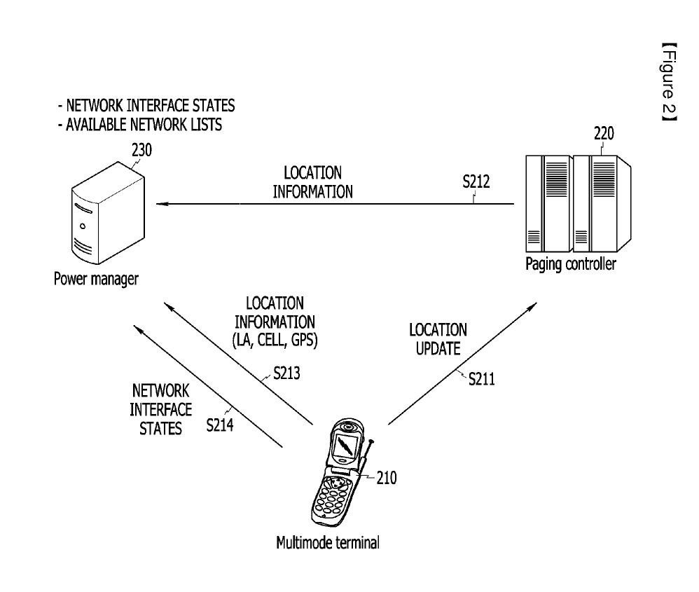

FIG. 2 shows a positional management system according to an embodiment of the present invention.

In the embodiment of the present invention, the positional management system includes a multimode terminal 210 mounted with the multimode interface, a paging controller 220, and a power manager 230.

The paging controller 220 transfers a paging request to the multimode terminal by grasping a current location of the multimode terminal when reception traffic toward the multimode terminal 210 is generated. Further, the paging controller 220 may perform location management of the terminal by receiving location information (for example, location area and tracking area) transmitted from the multimode terminal 210.

When the paging controller 220 receives a location update message transmitted from the multimode terminal 210 (S211), the paging controller 220 transfers location information of the multimode terminal included in the location update message to the power manager 230 (S212).

The power manager 230 manages information on heterogeneous networks accessible at a current location of the multimode terminal 210 (S213) and state information on the network interfaces of the multimode terminal 210 (S214).

One example of the power manager includes a power management functional entity (PMFE), etc. In the present invention, the power manager 230 may be independently formed by an additional device. Further, the power manager 230 may be implemented in the paging controller 220 or the multimode terminal 210 to perform a function.

The power manager 230 manages the location information of the multimode terminal 210 and heterogeneous network coverage distribution information (for example, see FIG. 1) in order to manage information on heterogeneous networks that are accessible at the current location of the multimode terminal 210 (S213).

The multimode terminal 210 may transmit information on location area to which the multimode terminal 210 currently belongs, location information acquired through a GPS system, and location area (LA) information and cell information that the multimode terminal 210 grasps in communication, etc., to the power manager 230 (S213). By this configuration, the power manager 230 grasps information on the heterogeneous networks that are accessible at the current location of the multimode terminal 210.

An embodiment of a method of acquiring location information of the multimode terminal 210 will be described below in detail. However, the following method corresponds to the embodiment proposed in the present invention and it should be understood that the method includes all ranges that can be easily substituted, changed, and derived from the concept of the present invention.

A) Utilizing Location Update Message of Broadband Wireless Network

A mobile terminal in the broadband wireless network such as 3G updates its own current location information to the paging controller when a specific LA is changed by moving between networks or when a specific predetermined time cycle elapses.

In the embodiment of the present invention, when the paging controller 220 receives the location update message from the multimode terminal 210 (S211), the paging controller 220 transfers the location information of the multimode terminal 210 to the power manager 230 (S212).

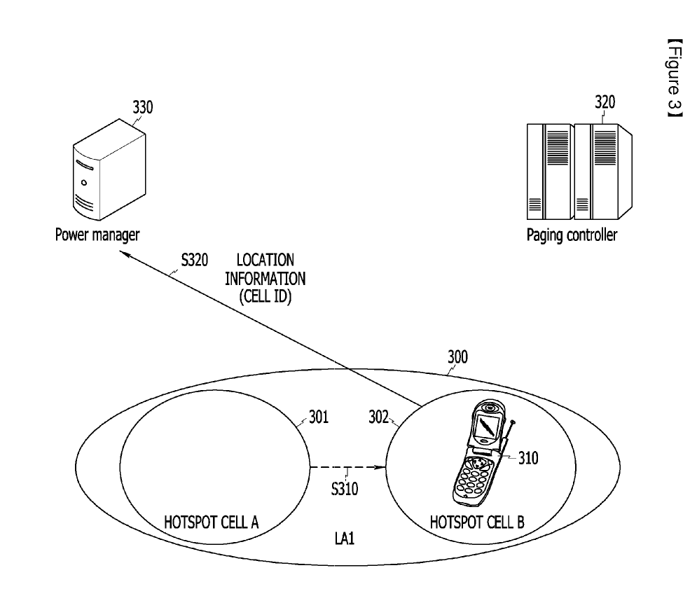

However, when it is difficult to transfer the location area information from the paging controller 220 to the power manager 230, it is possible to directly update the location area information from the multimode terminal 210 to the power manager 230 through an additional communication session (S213). The related matters refer to FIG. 3.

The power manager 230 verifies a heterogeneous network that is accessible in the location area to which the multimode terminal 210 currently belongs by using the location area information included in the received location update message.

For example, in FIG. 1, when the multimode terminal 210 moves into the area of Location Area 1 120, the power manager 230 acquires information on the location area in which the multimode terminal 210 is positioned. Thereafter, it can be verified that a heterogeneous network that the multimode terminal 210 can currently access is WiFi on the basis of the previously managed heterogeneous network coverage distribution information.

B) Utilizing GPS

The location of the multimode terminal 210 can be grasped by using a GPS system. The multimode terminal 210 transmits the location information to the power manager 230 at a predetermined cycle, or whenever a change in location that is geographically important is generated.

The power manager 230 can verify a heterogeneous wireless network that the multimode terminal 210 can currently access by utilizing the GPS location information received from the multimode terminal 210 and the previously stored heterogeneous network coverage distribution map information.

FIG. 3 shows a process of updating information by referring to states of network interfaces in a power manager according to an embodiment of the present invention.

An example of managing information on states of the network interfaces of the multimode terminal 210 in a power manager will be described below.

When a multimode terminal 310 moves between hotspot cells of the corresponding wireless connection network in a state in which a specific network interface of the multimode terminal 310 is “activated”, the location information (i.e., cell ID) of the newly connected hotspot cell is provided to a power manager 330.

For example, when the multimode terminal 310 moves from hotspot cell A 301 to hotspot cell B 302 in broadband location area 1 300 (S310), the multimode terminal 310 may provide the cell ID information including, for example, the WiFi Hotspot cell information of FIG. 1 to the power manager 330 (S320).

The power manager 330 can more accurately identify the location of the multimode terminal 310 on the basis of the hotspot cell information received from the multimode terminal 310.

Further, the power manager 330 may remotely control the states of the heterogeneous network interfaces mounted on the multimode terminal by utilizing information on the heterogeneous networks that are accessible at the current location of the multimode terminal 310 and the state information of the network interfaces of the multimode terminal.

For example, in FIG. 1, after the multimode terminal uses the WiFi network interface in location area 2 130 and terminates the application service (i.e., sleep or PSM state in the case of WiFi and sleep state in the case of WiMAX), the power manager may command the multimode terminal to power off the WiFi network interface.

Further, in FIG. 1, when the multimode terminal moves to location area 1 120 where the WiFi network is distributed in the state of powering off the WiFi network interface in location area 4 160, the power manager may command the multimode terminal 210 to power on the WiFi network interface.

According to the above-mentioned embodiment, when the multimode terminal terminates the application service after using the application service through a specific network interface and or the multimode terminal cannot access the corresponding network at the current location of the multimode terminal as the multimode terminal moves, the power manager may command the multimode terminal to power off the corresponding network interface.

Likewise, when a new network that can be connected through the network interface in the power off state is verified as the location of the multimode terminal moves, the power manager may command the multimode terminal to power on the corresponding network interface.

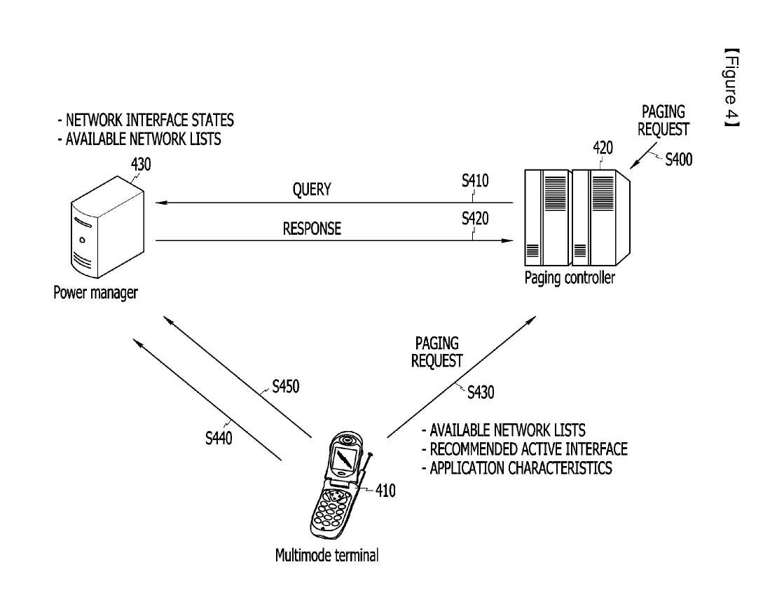

FIG. 4 shows a paging processing process for a multimode terminal according to an embodiment of the present invention.

The paging processing process for the multimode terminal may be classified into a process performed through steps S410 and S420, and a case in which a paging request message is transferred without steps S410 and S420.

First, an embodiment of the processing paging performed through steps S410 and S420 will be described below.

When a paging controller 420 receives the paging request message, the paging controller 420 queries states of heterogeneous network interfaces mounted on a multimode terminal 410 and information on a network list that the multimode terminal can currently access to a power manager 430 (S410).

The power manager 430 transmits the states of the heterogeneous network interfaces and the information on the network list that the multimode terminal can currently access in response to the query of the paging controller 420 (S420).

The paging controller 420 may be implemented depending on the states of the heterogeneous network interfaces, as follows.

A) In the case where all heterogeneous network interfaces are in a deactivated state

The paging controller 420 transmits the paging request to the multimode terminal 410. In this case, the paging request includes information such as the heterogeneous network list that the multimode terminal 430 can access at a current location, candidate active interfaces recommended by a network administrator, the characteristics of an application service that another communication counterpart that performs communication after a paging process wants to use, etc.

The multimode terminal 430 may start the application service by activating a specific network interface among a plurality of heterogeneous network interfaces on the basis of the above-mentioned information included in the paging request (S430).

For example, in FIG. 1, when the multimode terminal is in the area 121, the paging controller 420 may recommend the multimode terminal 410 to turn on WiFi as the candidate active interface. The multimode mobile terminal 410 checks the recommended candidate active interfaces to select an active interface that is suitable for the characteristics of the multimode mobile terminal 410.

B) In the Case where an Activated Heterogeneous Network Interface is Present

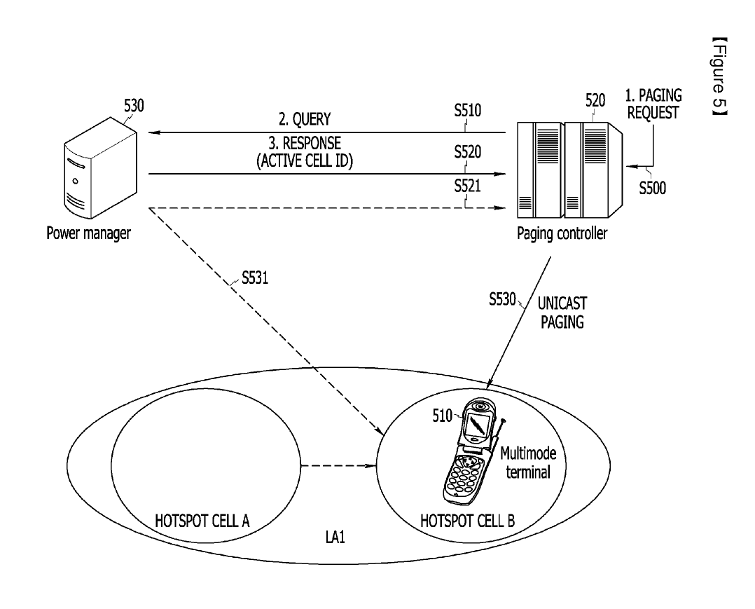

When a specific heterogeneous network interface among the plurality of heterogeneous network interfaces is in the activated state, the power manager 410 may verify information on a hotspot cell that the activated network interface currently accesses. That is, when the multimode terminal 430 moves while practically performing the communication, the paging controller 420 may transmit the paging request to the multimode terminal 430 by unicast. Related matters will be described in more detail with reference to FIG. 5.

Next, the case in which the paging request message is transferred without steps S410 and S420 will be described. When the multimode terminal 410 receives the paging request message, the multimode terminal 410 queries the states of the heterogeneous network interfaces mounted on the multimode terminal 410 and the information on the network list that the multimode terminal can currently access to the power manager 430 (S440). Thereafter, the multimode terminal 410 receives a response including the states of the heterogeneous network interfaces and the information on the network list that the multimode terminal can currently access from the power manager 430 (S450), and starts the service by activating an appropriate network interface.

FIG. 5 shows one example when a predetermined heterogeneous network interface is in an activated state during a paging processing process for a multimode terminal.

A paging controller 520 receives a paging request message (S500). Thereafter, the paging controller 520 queries states of network interfaces of a multimode terminal and information on accessible networks to a power manager 530 (S510). The paging controller 520 transmits the paging request message to a multimode terminal 510 that accesses the hotspot cell B through by unicast (S530).

The power manager 530 transmits the states of the heterogeneous network interfaces and the information on the network list that the multimode terminal can currently access in response to the query of the paging controller 520 (S520). Referring to the example of FIG. 5, the power manager 530 notifies information on a heterogeneous network interface that is currently in an activated state among the multimode interfaces of the multimode terminal 510 and information indicating that a cell that the multimode terminal 510 is currently accessing is the hotspot cell B to the paging controller 520.

The power manager 530 transmits the paging request message directly to the multimode terminal 510 by unicast (S531), and the power manager 530 may respond by notifying only concise hotspot cell information and a processing result to the paging controller 520 (S521). In this case, referring to the example of FIG. 5, the power manager 530 transmits the paging request message to the multimode terminal in a type of message that is suitable for a hotspot cell network. When the power manager 530 transmits the paging request message directly to the multimode terminal 510, step S530 in which the paging controller 520 transmits the paging request message to the multimode terminal 530 is omitted.

As such, according to an embodiment of the present invention, it is possible to minimize power consumption by only powering on a used heterogeneous network interface and powering off the remaining heterogeneous network interfaces depending on the current location of a multimode terminal.

Further, when a narrowband wireless connection network interface is in an activated state, unicast paging processing is available by updating more precision location information of a hotspot cell, thereby reducing a burden of the existing broadcast-type paging processing and preventing a burden of signaling on a network backbone and unnecessary waste of radio resources.

The present invention may be implemented as a computer-readable code in a computer-readable recording medium. The computer-readable recording media includes all types of recording apparatuses in which data that can be read by a computer system is stored.

Examples of the computer-readable recording media include a ROM, a RAM, a CD-ROM, a magnetic tape, a floppy disk, an optical data storage unit, a non-memory semiconductor, etc., and in addition, they include a recording medium implemented in the form of a carrier wave (for example, transmission through the Internet). Further, the computer-readable recording media are distributed on computer systems connected through the network, and thus the computer-readable recording media may be stored and executed as a computer-readable code by a distribution scheme.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A power management apparatus, comprising:
a storage unit that stores a map displaying a communication coverage area of a heterogeneous network;
a receiver that receives location information of a terminal having heterogeneous network interfaces and receives state information indicating states of the heterogeneous network interfaces; and
a manager that manages a list of heterogeneous networks that are accessible at the current location of the terminal by using the map stored in the storage unit, the location information, and the state information.

2. The power management apparatus of claim 1, further comprising a network interface controller that controls power of the heterogeneous network interfaces mounted on the terminal so as to selectively supply power only to a heterogeneous network interface corresponding to the list of the accessible heterogeneous networks.

3. The power management apparatus of claim 1, further comprising a providing unit that provides information on the list of the heterogeneous networks that are accessible at the current location of the terminal.

4. A method for managing a power in a power management apparatus, the method comprising:
storing a map displaying communication coverage areas of heterogeneous networks;
receiving location information of a terminal mounted with heterogeneous network interfaces and state information indicating states of the heterogeneous network interfaces; and
managing a list of heterogeneous networks that are accessible at the current location of the terminal by using the map, the location information, and the state information.

5. The method of claim 4, further comprising controlling power of the heterogeneous network interfaces mounted on the terminal so as to selectively supply power only to a heterogeneous network interface corresponding to the list of the accessible heterogeneous networks.

6. The method of claim 4, further comprising providing information on the list of the heterogeneous networks that are accessible at the current location of the terminal.

7. The method of claim 4, wherein the map displaying the communication coverage area of the heterogeneous network includes information on a physical region-based location of the heterogeneous network, a location of a broadband wireless access network, and a location of a narrowband wireless hotspot cell.

8. The method of claim 4, wherein, in the receiving step, the current location of the terminal is grasped by receiving information of a location area that is changed as the terminal moves between broadband wireless access network areas.

9. The method of claim 4, wherein the current location of the terminal is acquired by using a GPS system.

10. The method of claim 4, wherein, in the receiving step, when the terminal moves between hotspot cells of a wireless access network, the current location of the terminal is identified by receiving information on a hotspot cell which the terminal newly accesses.

11. The method of claim 4, wherein the state of each of the heterogeneous network interfaces is configured depending on whether or not power is supplied to the correpsonding heterogeneous network interface.

12. The method of claim 4, wherein, when the terminal receives traffic, the state of each of the heterogeneous network interfaces is set depending on whether or not the received traffic is processed through the corresponding heterogeneous network interface.

13. The method of claim 12, wherein the state of each of the heterogeneous network interfaces is set to a state (REACHABLE_DIRECTLY) in which an application service session can be started with respect to the reception traffic through the corresponding heterogeneous network interface, to a state (NON_REACHABLE) in which communication cannot be started through the corresponding heterogeneous network interface, and to a state (REACHABLE_INDIRECTLY) in which the communication cannot be started through the corresponding heterogeneous network interface but the application service session can be started by switching a heterogeneous network interface that cannot start the communication into the activation state through another heterogeneous network interface attached to the terminal.

14. The method of claim 4, wherein the list of the accessible heterogeneous networks is adjusted whenever the received information on the current location of the terminal or the state of the heterogeneous network interface is changed.

15. The method of claim 4, wherein, in a case that all heterogeneous network interfaces mounted on the terminal are in a deactivated state when a paging controller receives a paging request message, the terminal receives the paging request message including the list of the heterogeneous networks that are accessible at the current location of the terminal from the paging controller.

16. The method of claim 4, wherein, in a case that a specific heterogeneous network interface is in an activated state among the heterogeneous network interfaces mounted on the terminal when the paging controller receives the paging request message, the terminal receives the paging request message through the specific heterogeneous network interface from the paging controller or the power management apparatus.

17. The method of claim 4, wherein the terminal receives the paging request message by unicast.
